(19) United States
(12) Patent Application Publication
(10) Pub. No.: US 2017/0176157 A1
(43) Pub. Date: Jun. 22, 2017

(54) LOW COST GUIDED MUNITION CAPABLE OF DEPLOYMENT BY MOST SOLDIERS

(71) Applicant: Dak Brandon Steiert, Edwards, CO (US)

(72) Inventor: Dak Brandon Steiert, Edwards, CO (US)

(21) Appl. No.: 14/971,683

(22) Filed: Dec. 16, 2015

(51) Int. Cl. F42B 15/01; G01S 13/88; G01S 19/18

(52) U.S. Cl. CPC F42B 15/01; G01S 19/18; G01S 13/883

(57) ABSTRACT

As shown in FIG. 1, the system of the first preferred embodiments is a video guided munition including: a body; at least two fin segments attached to the body near the rear of the body; at least two actuators attached to at least one of the fins and the body, where the actuators are adapted to move at least one of A) a control surface on at least one of the fins and B) the fins, where the movement creates aerodynamic forces adapted to control the direction of the flight of the munition; a video camera mounted at least one of I) to the body and II) to another component mounted to the body; a video transmitter in electrical communication with the video camera and adapted to transmit video from the video camera; a control receiver designed to receive electromagnetic control signals, where the control receiver is in electrical communication with the at least two actuators, where the control receiver is adapted to provide control signals to the at least two actuators; a control transmitter, where the control transmitter is adapted to transmit electromagnetic control signals to the control receiver; control inputs mounted on the control transmitter and designed to allow a user to provide control inputs to the control transmitter; a video display; a video receiver in electrical communication with the video display, wherein the video receiver is designed to receive the video transmitted by the video transmitter, wherein the video display shows video transmitted by the video transmitter to the user; wherein the user reacts to the transmitted video on the video display to provide control inputs to guide the video guided munition to a desired target point; at least one of an explosive warhead and a non-lethal weapons payload; a launch system comprising at least one of 1) an elastic launcher, 2) a spring launcher, 3) a compressed gas launcher, and 4) an adapter that allows the munition to be launched by a firearm. The system of the preferred embodiments is preferably designed to provide a low cost, guided weapon that is compact enough that a single soldier can carry multiple munitions, that does not require a significant launcher to be carried, that is inexpensive enough to equip a large fraction of the troops on the battle field, that can achieve hits at 200 meters to 800 meters in range, that can hit targets that are not in line of sight, and that has the power and guidance effectiveness to get hits after only several rounds are expended at most while again being inexpensive enough that this is acceptable—no such system or any system with a capability remotely like this exists in the prior art. The system of the preferred embodiments may, however, be used for any suitable reason.

### BRIEF DESCRIPTION OF THE FIGURES

FIG. 1 is a schematic representation of a variation of the system of the first preferred embodiments.

FIG. 2 is a schematic representation of a variation of the system of the first preferred embodiments, where an elastic launcher is used.

FIG. 3 is a schematic representation of a variation of the system of the first preferred embodiments, where a spring launcher is used.

FIG. 4 is a schematic representation of a variation of the system of the first preferred embodiments, where a firearm with an adapter is used to launch the video guided munition.

FIG. 5 is a schematic representation of a variation of the system of the first preferred embodiments, where wings are attached within three inches of the center of gravity, and where a warhead adapter is used to attach at least one of 1) an existing grenade, 2) an existing grenade warhead, and 3) a grenade projectile from an existing grenade launcher to the body, and where the distance to the target point is shown.

FIG. 6 is a schematic representation of a variation of the system of the first preferred embodiments, where a firearm with an adapter is used to launch the video guided munition, where the range to the target is shown.

FIG. 7 is a schematic representation of a variation of the system of the first preferred embodiments, where the wing is designed to fold for easy storage, where a warhead adapter is adapted to attach to at least one of A) the projectile from a NATO standard 40 mm grenade launcher round, B) the projectile from a NATO standard 25 mm grenade launcher round, C) a NATO standard 40 mm grenade launcher warhead, and D) a NATO standard 25 mm grenade launcher warhead.

FIG. 8 is a schematic representation of a variation of the system of the second preferred embodiments.

FIG. 9 is a schematic representation of a variation of the system of the second preferred embodiments, where the wing is designed to pivot for easy storage, where a warhead adapter is adapted to attach to at least one of A) the projectile from a NATO standard 40 mm grenade launcher round, B) the projectile from a NATO standard 25 mm grenade launcher round, C) a NATO standard 40 mm grenade launcher warhead, and D) a NATO standard 25 mm grenade launcher warhead.

FIG. 10 is a schematic representation of a variation of the system of the second preferred embodiments, where a ground station with a control circuit receives a sensor signal, executes a control algorithm, and transmits a control signal back to the rifle launched guided munition to guide it to the target.

FIG. 11 is a schematic representation of a variation of the system of the second preferred embodiments, where a ground station with a control circuit receives a signal from a video camera sensor and displays the video on a touch sensitive display, where a user touches a desired target point, where the control circuit executes the control algorithm with the video camera sensor signal and the touch sensitive display signal as inputs, where the control signal transmitter transmits the signal to the rifle launched guided munition to guide it to the target point the user is touching on the touch sensitive display.

FIG. 12 is a schematic representation of a variation of the system of the second preferred embodiments, where the rear of the body of the rifle launched munition slides over a flash hider on a standard military rifle and acts as the adapter for use with a firearm, where a bullet trap allows a live firearm cartridge to be used to launch the rifle launched guided munition.

FIG. 13 is a schematic representation of a variation of the system of the second preferred embodiments, where a telescoping tube adapter that slides over the flash hider is included.

FIG. 14 is a schematic representation of a variation of the system of the second preferred embodiments, where a telescoping tube adapter that slides over the flash hider is included, shown during launch with the telescoping motion in the middle of its range.

### DESCRIPTION OF THE PREFERRED EMBODIMENTS

The following description of the preferred embodiments of the invention is intended to enable someone skilled in the prior art to make and use this invention, but is not intended to limit the invention to these preferred embodiments.

### 1. First Preferred Embodiment

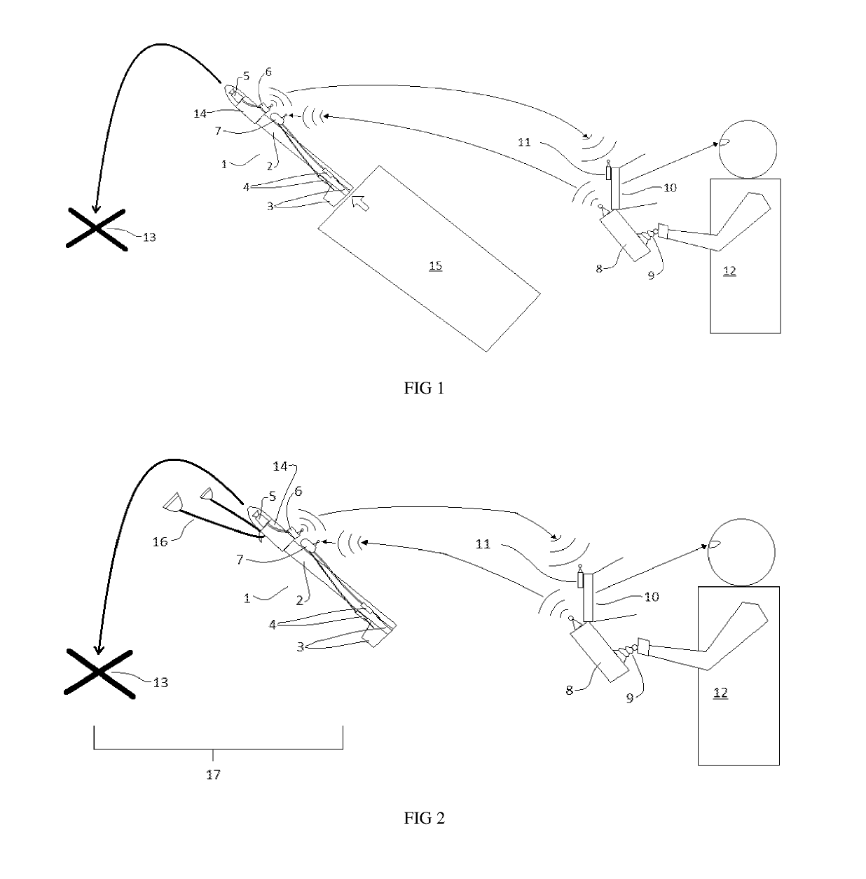

As shown in FIG. 1, the system of the first preferred embodiments is a video guided munition 1 including: a body 2; at least two fin segments 3 attached to the body 2 near the rear of the body 2; at least two actuators 4 attached to at least one of the fins and the body 2, where the actuators 4 are adapted to move at least one of A) a control surface 31 on at least one of the fins and B) the fins, where the movement creates aerodynamic forces adapted to control the direction of the flight of the munition; a video camera 5 mounted at least one of I) to the body 2 and II) to another component mounted to the body 2; a video transmitter 6 in electrical communication with the video camera 5 and adapted to transmit video from the video camera 5; a control receiver 7 designed to receive electromagnetic control signals, where the control receiver 7 is in electrical communication with the at least two actuators 4, where the control receiver 7 is adapted to provide control signals to the at least two actuators 4; a control transmitter 8, where the control transmitter 8 is adapted to transmit electromagnetic control signals to the control receiver 7; control inputs 9 mounted on the control transmitter 8 and designed to allow a user 12 to provide control inputs 9 to the control transmitter 8; a video display 10; a video receiver 11 in electrical communication with the video display 10, wherein the video receiver 11 is designed to receive the video transmitted by the video transmitter 6, wherein the video display 10 shows video transmitted by the video transmitter 6 to the user 12; wherein the user 12 reacts to the transmitted video on the video display 10 to provide control inputs 9 to guide the video guided munition 1 to a desired target point 13; at least one of an explosive warhead 14 and a non-lethal weapons payload; a launch system 15 comprising at least one of 1) an elastic launcher 16, 2) a spring launcher 18, 3) a compressed gas launcher, and 4) an adapter 20 that allows the munition to be launched by a firearm 19. The system of the preferred embodiments is preferably designed to provide a low cost, guided weapon that is compact enough that a single soldier can carry multiple munitions, that does not require a significant launcher to be carried, that is inexpensive enough to equip a large fraction of the troops on the battle field, that can achieve hits at 200 meters to 800 meters in range 17, that can hit targets that are not in line of sight, and that has the power and guidance effectiveness to get hits after only several rounds are expended at most while again being inexpensive enough that this is acceptable—no such system or any system with a capability remotely like this exists in the prior art. The system of the preferred embodiments may, however, be used for any suitable reason.

As shown in FIG. 1, the video guided munition 1 of the first preferred embodiments includes a body 2 that is designed to mount all of the other components, provide structural support, and provide appropriate aerodynamic characteristics. In a preferred variation, the body 2 is made of at least one of metal, polymer, and polymer composites such as carbon fiber. In a preferred variation the body 2 is made of a metal tube. The body 2 may, however, be made of any suitable material in any suitable shape.

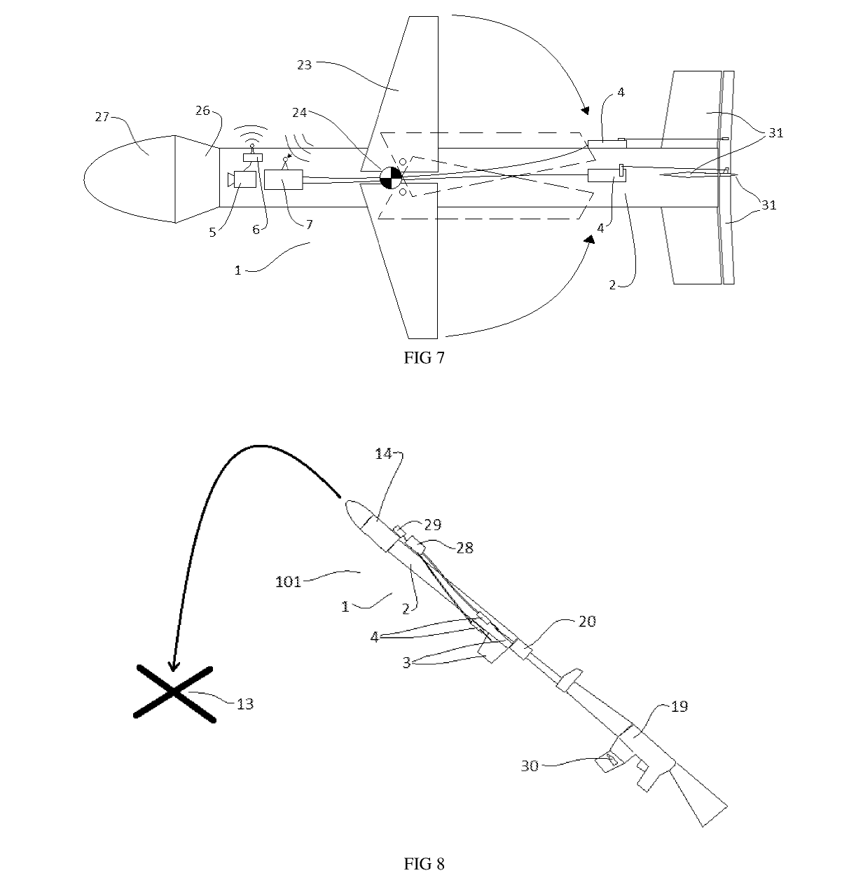

As shown in FIGS. 1 and 7, the video guided munition 1 of the first preferred embodiments includes at least two fin segments 3 attached to the body 2 near the rear of the body 2. In one variation the fins are each attached separately to the body 2. In another variation, at least two fins are attached to the body 2 in a single fin segment 3 that extends bilaterally past the body 2. In a preferred variation, there is a fin segment 3 that extends bilaterally to past the body 2 and acts as the horizontal stabilizer, and another fin segment 3 that is attached to the body 2 and extends vertically on one side of the body 2 and acts as the vertical stabilizer. At least two actuators 4 are attached to at least one of the body 2 and the fins. If a single actuator 4 capable of separately producing two separate force or torque outputs is used, this would still act as two actuators 4. The actuators 4 are designed to move at least one of the fin segments 3 and control surfaces 31 attached to the fins, and this movement creates aerodynamic forces that allows the flight of the video guided motion to be controlled. In a preferred variation, at least one actuator 4 controls the lift on the horizontal stabilizer by moving at least one of A) at least one control surface 31 attached to the at least one horizontal stabilizer, and B) the at least one horizontal stabilizer. In this preferred variation, this at least one actuator 4 controls the pitch of the video guided munition 1 in flight. In this preferred variation, at least one second actuator 4 controls the lift on the vertical stabilizer by moving at least one of A) at least one control surface 31 attached to the at least one vertical stabilizer, and B) the at least one vertical stabilizer. In this preferred variation, this at least one actuator 4 controls the yaw of the video guided munition 1 in flight. In another preferred variation where a wing is attached to the body 2 of the video guided munition, at least one actuator 4 may control at least two control surfaces 31 attached to the rear of the wings 23 bilaterally, where the wing can be considered at least one additional fin segment 3 with specific placement and surface area, where these at least two control surfaces 31 may act as ailerons, where this at least one actuator 4 would control the roll of the video guided munition 1 in this variation. The video guided munition 1 requires control in at least yaw and pitch in one preferred variation. In another preferred variation the guided munition requires control in at least pitch and roll. In one preferred variation, as seen in FIG. 7, control surfaces 31 are an additional strip of material pivotally attached behind the fin segment. In one variation of this variation, the control surface 31 may be attached to the fin segment 3 by a flexible polymer sheet joined to the fin segment 3 and to the control surface 31 by an adhesive. In another variation of this variation, the control surface 31 may be attached to the fin segment 3 by a hinge. The control surfaces 31 may, however, be attached to the fin segments 3 by any suitable means allowing the proper movement of the control surfaces 31. In a preferred variation, a control horn is attached to the control surfaces 31, providing a lever arm rising away from the plane of the control surface 31 such that a push and pull action of a control rod attached to the control horn causes the control surface 31 to rotate relative to the joint connecting it to the fin segment, where this rotation leads to varying aerodynamic forces. In this preferred variation, at least one control rod is connected to each actuator 4 and to at least one control horn connected to each control surface, where this design allows the actuators 4 to pivot the control surfaces 31. In another preferred variation, the fin segments 3 are attached pivotally to the body 2 such that the entire fin segment 3 can be pivoted by the actuators 4 in order to vary aerodynamic forces and exert control on the flight path of the video guided munition. The fin segments 3, actuator, and control scheme may, however, have any suitable layout and be constructed in any suitable manner. In one preferred variation, the fin segments 3 are made of at least one of metal, polymer, and polymer composites. In one preferred variation, the fin segments 3 are thin, flat segments of sheet material. In another preferred variation, the fin segments 3 have an appropriate airfoil shaped cross section. In this variation, the range 17 and maneuvering capabilities of the video guided munition 1 may result from decreased drag and increased airfoil performance, but the tradeoff in increased cost may not justify using fin segments 3 with airfoil shaped cross-sections. The fin segments 3 may, however, be constructed of any suitable material in any suitable shape.

In one variation, the actuators 4 may be servo actuators 4 with arms attached to the control rods, as are commonly used in prior art RC airplanes. In another variation, the actuators 4 may be solenoids. In another variation, the actuators 4 may be muscle wire actuators 4. The actuators 4 may, however, be of any suitable type and design. Preferably the actuators 4 are light enough in weight, low enough in cost, and powerful enough to control the video guided munition 1 while not hindering its performance or adding significantly to its cost.

As shown in FIG. 1, the video guided munition 1 of the first preferred embodiments includes a video camera 5 attached to a video transmitter 6. The video transmitter 6 transmits the video signal to a video receiver 11 attached to a video display 10 that is designed to show the video from the video camera 5 to a user 12. The video display 10 can be a screen, a goggle mounted display, a prismatic display projected onto a lens in front of the user's 12 eye, and any other suitable video display 10. The video transmitter 6 uses electromagnetic waves to transmit the video signal to the video receiver 11. In a preferred variation, the video transmitter 6 may use at least one of radio waves, microwaves, a laser transmitter, and any other suitable electromagnetic communications method. The video guided munition 1 also includes a control receiver 7 designed to receive control inputs 9 from a control transmitter 8, where the control receiver 7 is also in electrical communication with the at least two actuators 4 and is designed to control the actuators 4 in order to guide the flight path of the video guided munition. The control transmitter 8 is connected to a control input which receives inputs from a user 12 to produce a control signal that the control transmitter 8 transmits via electromagnetic waves to the control receiver 7. In a preferred variation, the control signal is transmitted using at least one of radio waves, microwaves, a laser transmitter, and any other suitable form of electromagnetic transmission. In one preferred variation, the control signal is an analog signal. In another preferred variation, the control signal is a digital signal. In one preferred variation, the control signal may be encrypted to avoid having the control signal interfered with by outside sources, and to avoid having control of the munition taken by outside sources. In another preferred variation, the control signal may be transmitted using a frequency hopping scheme. In a variation of this variation, before launch the control transmitter 8 and control receiver 7 may synchronize a timed series of frequency hops in which the transmitter and receiver both switch frequencies multiple times at the same time, where the timing and frequencies chosen are preferably at least one of difficult to predict and randomized, where this is designed to avoid having control of the video guided munition 1 jammed, interfered with, and taken by outside sources. The control signal may, however, be transmitted via any suitable means and in any suitable way.

As shown in FIG. 1, the user 12 watches the video display 10 transmitted from the video camera 5 in the video guided munition 1 while the video guided munition 1 is in flight, and the user 12 interacts with the control inputs 9 to guide the video guided munition 1 towards a desired target point 13. In one preferred variation, at least one of cross hairs and another indicator of the exact direction of flight of the video guided munition 1 may be included on at least one of the video display 10 and the physical lens cover of the video camera 5, where the at least one of cross hairs and another indicator assists the user 12 in precisely guiding the flight of the video guided munition. In a variation of this variation, the user 12 may attempt to manipulate the control inputs 9 such that the cross hairs stay over a target point 13 until the video guided munition 1 makes impact. There may, however, be no aide for helping the user 12 guide the video guided munition 1 whatsoever. The control inputs 9 may be at least one of a joy stick, a directional pad, a touch screen, an eye tracking sensor, an EEG sensor capable of reading neural activity, and any other suitable method of taking input from a user 12 to generate a control signal to transmit to the video guided munition. In a preferred variation, the control input includes at least one joystick. The control inputs 9 may, however, be any suitable means for interfacing with the user 12.

In a preferred variation, none of laser guidance control sensors, infrared seeking sensors, GPS guidance control sensors, and RADAR guidance control sensors provide input to the actuators 4. Feedback control based on these sensor systems is expensive and takes a great deal of development and testing to deliver accurate and reliable results. In prior art systems, no guided munitions based on feedback control using these systems have been created for less than several thousand dollars and generally over ten thousand dollars by the time all development and reliability work has been built into the systems. The system of the preferred embodiments is preferably designed to be low enough cost that it would be affordable to deliver several of the video guided munitions to every group of four or fewer troops on the battlefield, or even to every troop on the battlefield; this requires unit costs in the range of several hundred dollars. Thus no prior art systems are capable of being accurately guided toward a target point 13 while maintaining systems that can be delivered with acceptable reliability for costs in the hundreds of dollar range, which is largely due to the fact that small guided munitions in the prior art include automated feedback control based on sensors including laser guidance control sensors, infrared seeking sensors, GPS guidance control sensors, and RADAR guidance control sensors. In a preferred variation the video guided munition 1 does not provide any input to the actuators 4 based on automated feedback from any type of sensor other than gyroscopic sensors, accelerometers, and inertial sensors, again to reduce cost. In one preferred variation, the video guided munition 1 may have a “fly-by-wire” system where input from at least one of gyroscopic sensors, accelerometers, and inertial sensors assists the user 12 in flying the device reliably and getting it to the target point 13. In another preferred variation, no automated systems provide any control inputs 9 to the actuators 4, and there is not automated feedback control taking data from a sensor and creating actuator 4 input of any kind. In this preferred variation, the user 12 provides all control input and this provides a low cost system. In this preferred variation, it is also possible to use many off-the-shelf electrical components without needing to accommodate any custom programming, and without needing to accommodate any custom control circuitry. The system may, however, use any suitable sourcing of off-the-shelf and purpose built circuits and components. The system may, however, use any suitable mix of user 12 control and automated control. The system may, however, use any suitable forms of feedback stabilization and feedback control. The system may, however, use fully automated control. Prior art systems are very expensive because they are designed to reliably have great accuracy, in a preferred variation the system of the preferred embodiments involves design decisions very unique from the prior art because it leads to a system capable of great accuracy but using the control abilities of a human user 12 in order to reduce cost; this may lead to some variation in accuracy and a decrease in hit probability, but this is preferably offset by making the video guided munition 1 affordable enough that it can be deployed so prevalently that the tradeoff of lower precision is more than compensated for by enabling a large fraction of battlefield troops access to guided munitions at all, which are vastly superior to standard firearms, grenades, grenade launchers, mortars, recoilless rifles, and unguided rockets. In this preferred variation, the system has many unique design choices compared to any prior art device because it is better to bring costs down enough that troops can be equipped with a reasonably accurate guided munition rather than unguided munitions; if design choices similar to prior art systems were made, a higher precision munition might be created but it would be too expensive to carry out widespread equipping of troops with the system. Nothing like this system has been created in the prior art, and nothing in the prior art has made the proper selection of features and combined them in a system such that an effective, low cost, transportable, and guided munition could widely equip troops. On top of cost, range, size, weight, and launching system are all aspects of a design that must be properly designed in order to achieve the ability to distribute a guided system to a large fraction of troops on the battlefield. Conflicts in modern battles generally involve two sides taking cover at between 100 meters and 800 meters from each other. A system to address this issue must be capable of attacking targets that are not in line of sight, and that are in this range. Furthermore, troops should be able to carry multiple munitions in the case that at least one does not impact its target, to allow addressing multiple threats, and to prevent troops from hesitating to deploy their guided munitions. Also, the troops should not have to carry a large dedicated launch system to launch the munitions as it generally requires that a soldier then must be specialized to carrying that launch system. Prior art systems using dedicated launch systems also become prohibitively expensive due to the cost of the launch system. Many conflicts require reaching targets over 200 meters and behind cover. Conflicts at up to 400 meters are common as well. In order to get munitions to these ranges, the vast majority of prior art systems have included propulsion systems in the munitions, including rocket engines and electric motors with propellers. Adding propulsion systems to the munitions greatly increases their cost, no matter the type of propulsion system. Thus, it is desired to create a munition not requiring an onboard propulsion system to reach the desired range 17. Thus, no system in the prior art is small enough that a single soldier can carry several of the munitions in addition to the soldier's standard armament, while also not requiring a large and expensive dedicated launcher, while also being capable of reaching targets at least 200 meters away on level ground at sea level, while also being guided, while also being low cost enough to be distributed to a large fraction of an entire military force. There has been significant need for such a system for thousands of years, as guided munitions allow a much greater effect from a given weight and number of munitions. Because a single soldier is limited in the weight and number of munitions they can carry, making those munitions guided means increasing the effectiveness of a given soldier by many times, and provides a revolutionary advance that meets a need that has been obvious for thousands of years but has never been satisfied. The system of the preferred embodiments may, however, meet any suitable design methodology. The design choices of the system of the preferred embodiments may, however, be made for any suitable reasons. The elements of the system of the preferred embodiments may, however, be combined in any suitable manner. The cost and performance of the system of the preferred embodiments may, however, be at any suitable level.

As shown in FIG. 1, the system of the preferred embodiments includes at least one of a lethal payload, an explosive warhead 14, and a non-lethal weapons payload. Because the system is guided but in some preferred variation is not guided by a high precision automated feedback control, it is preferable if the weapons system is capable of disabling at least one of enemy soldiers and enemy machinery within a certain radius of the impact of the video guided munition. Non-lethal payloads 14 may include teargas, electromagnetic pulse devices, “flash bang” type devices, and any other suitable payload 14 for at least temporarily disabling at least one of enemy combatants and machinery. In one preferred variation, a warhead adapter 21 is attached to the body 2 and the warhead adapter 21 is designed to attach at least one of 1) an existing grenade 22, 2) an existing grenade warhead 22, and 3) a grenade projectile 22 from an existing grenade launcher to the body 2, where the at least one of 1) the existing grenade 22, 2) the existing grenade warhead 22, and 3) the grenade projectile 22 from an existing grenade launcher acts as the explosive warhead 14 of the video guided munition. In this preferred variation, the wide variety of existing explosive munitions can be used to provide a lower cost, previously developed explosive device as a warhead for a video guided munition 1 by using the warhead adapter 21. In one variation, the warhead adapted uses at least one of threads, adhesive, at least one clamp, and a friction fitting for attaching the existing explosive device as a warhead. There may, however, be any suitable attachment method. In another preferred variation, a warhead adapter 26 is adapted to attach to at least one of A) the projectile 27 from a NATO standard 40 mm grenade launcher round, B) the projectile 27 from a NATO standard 25 mm grenade launcher round, C) a NATO standard 40 mm grenade launcher warhead 27, and D) a NATO standard 25 mm grenade launcher warhead 27, wherein the at least one of A) the projectile 27 from a NATO standard 40 mm grenade launcher round, B) the projectile 27 from a NATO standard 25 mm grenade launcher round, C) a NATO standard 40 mm grenade launcher warhead 27, and D) a NATO standard 25 mm grenade launcher warhead 27 acts as the explosive warhead 14 of the video guided munition. There are a large variety of different warhead and projectile types that have been developed for use in NATO 40 mm and 25 mm grenade launchers, these systems are designed to be lightweight enough for use in ballistic applications, and they are designed to accomplish similar goals in terms of fuzing and target effect. The system may, however, use any suitable warhead. The system may, however, use a custom designed warhead. The system may, however, use any suitable payload.

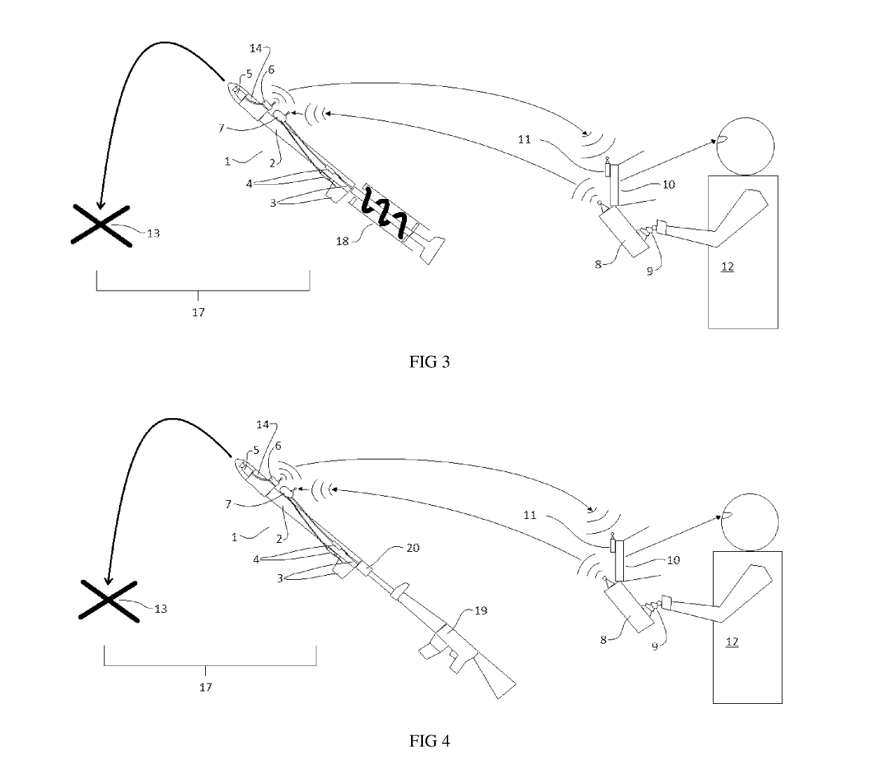

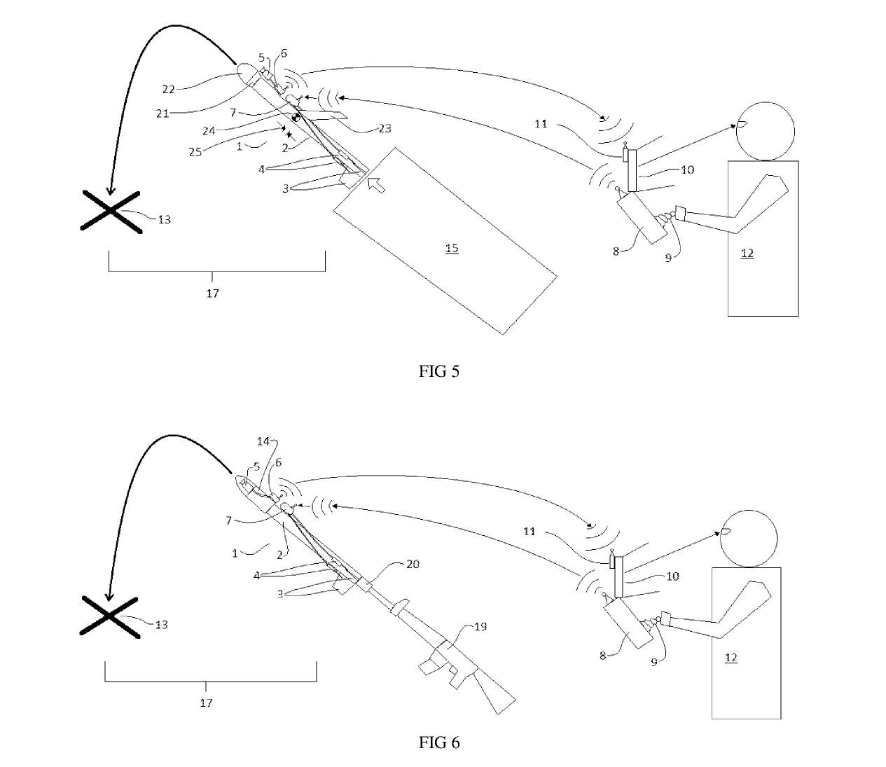

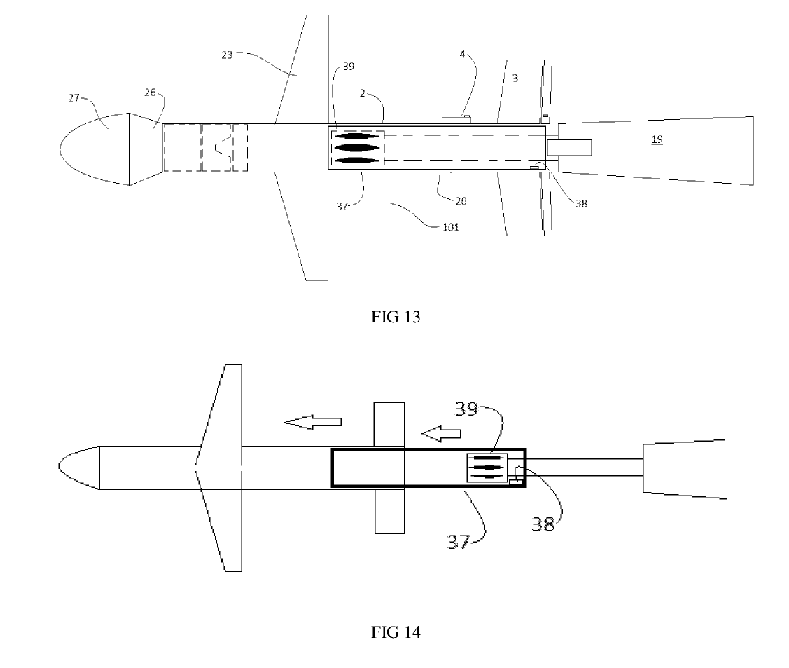

The system of the first preferred embodiments requires a launcher capable of launching the video guided munition 1 with sufficient energy for it to reach a usable range 17. In a preferred variation, the launcher may be at least one of 1) an elastic launcher 16, 2) a spring launcher 18, 3) a compressed gas launcher, and 4) an adapter 20 that allows the munition to be launched by a firearm 19. As shown in FIG. 2, in a preferred variation an elastic launcher 16 can be used to launch the video guided munition. A variation of this variation includes a launcher using at least one of an elastic band, an elastic tube, an elastic cord, and a bundle of elastic fibers. In a variation of this variation, a hook is attached to the body 2 and the launcher includes two handles on either end of an elastic member including at least one of an elastic band, an elastic tube, an elastic cord, and a bundle of elastic fibers, where at least one soldier can hold the handles and at least one additional soldiers stretches the elastic member back with the video guided munition 1 hooked onto the elastic member and then lets go, launching the video guided munition. This variation provides a very quite and hard to detect launch means, allows for a very compact and lightweight launcher to be easily carried, and can provide a great deal of kinetic energy at launch for the video guided munition, allowing the video guided munition 1 to attain ranges great enough for practical use and potentially allowing larger munitions than with other launch means. In another preferred variation, a launcher using an elastic member including at least one of an elastic band, an elastic tube, an elastic cord, and a bundle of elastic fibers is constructed similarly to a spear fishing gun, with a trigger mechanism and a frame, and this launching device is used to launch the video guided munition. In another variation, as shown in FIG. 3 a launcher using a spring may be used to launch the video guided munition. In another variation, a compressed gas launcher may be used to launch the video guided munition. As shown in FIG. 4 in a preferred variation, an adapter 20 may be used to allow the video guided munition 1 to be launched by a standard firearm 19. In a variation, an attachment may be mounted to the firearm 19 barrel and at least a portion of the video guided munition 1 body 2 may be inserted into the attachment mounted to the firearm 19, and at least one of the gases from the firearm 19 and the bullet fired by the firearm 19 impart a launch energy to the video guided munition. In another preferred variation, as shown in FIG. 12, at least one of A) an adapter 20 may be attached to the rear of the body 2 which is designed to slide over a standard firearm 19 barrel, and B) at least the rear portion of the body 2 may be designed to slide over a standard firearm 19 barrel, where at least one of the gases and the bullet fired by the firearm 19 impart a launch energy to the video guided munition. In one preferred variation of this variation, the rear of the body 2 may be designed to fit over standard military firearm 19 flash hiders and slide down over a portion of the barrel, allowing the video guided munition 1 to be launched from a variety of unmodified military firearms 19. As shown in FIGS. 13 and 14, in a preferred variation a telescoping tube 37 adapter is used where a telescoping tube 37 slides over the flash hider and is designed to extend forward past the muzzle of the firearm 19 during launch, and where the at least one of rear of the body 2 of the rifle launched guided munition 101, and an adapter attached to the rifled guided munition then slides at least one of over and into the telescoping tube 37; the telescoping tube 37 has at least one of a stop 38 and a catch 38 that at least one of prevents it from sliding fully forward off of at least one of the flash hider and the rifle barrel, so that when the firearm 19 is discharged the rifle launched guided munition 101 begins moving forward and the telescoping tube 37 begins extending and sliding forward, then hits the at least one of the catch 38 and the stop 38 and the rifle launched guided munition 101 continues to move forward as at least one of the rear of its body 2 and an adapter attached to its body slides at least one of off of and out of the telescoping tube 37. In this preferred variation, the time and distance during launch that the gases discharged from the firearm 19 can be enclosed and used to propel the rifle launched guided munition 101 are nearly doubled, providing a significantly higher ability to impart kinetic energy to the rifle launched guided munition 101 from a cartridge 30 of a given power; this may help the rifle launched guided munition 101 to reach ranges 17 of 400 meters or more when launched with the power of a NATO standard 5.56×45 mm cartridge 30 or similar international cartridges 30, which would greatly help in deploying the system to a large fraction of troops on the battlefield. In a preferred variation, as shown in FIG. 12 the body 2 of the video guided munition 1 may include a bullet trap designed to allow a live cartridge 30 to be fired by the firearm 19, where the bullet from the cartridge 30 is trapped by the bullet trap without damaging the video guided munition, while the momentum of the bullet and the gases from firing the cartridge 30 are used to launch the video guided munition. A number of rifle grenade bullet traps are known in the prior art, though in one variation as shown in FIG. 12 a rubber plug may be placed to the rear of a sliding metal piston with at least one of a small diameter depression and a conical depression in the aft face of the piston, where the bullet will pass through the rubber plug and strike the depression in the piston, being relatively contained by the piston while the rubber plug prevents impact particles from flying back towards the firearm 19; this variation of the bullet trap further includes a piece of light foam placed on the far side of the sliding metal piston, so that the bullet strikes the piston and is generally contained by the depression and the piston slides in the body 2 but is resisted and decelerated by the piece of light foam. There may, however, be any suitable design of bullet trap. There may, however, be no bullet trap whatsoever in the video guided munition. In another variation, blank cartridges 30 may be used to launch the video guided munition. In another preferred variation, the video guided munition 1 is designed to be launched by a standard firearm 19, and the video guided munition 1 also includes a hook to enable launching the video guided munition 1 with an elastic launcher 16.

In a preferred variation, the video guided munition 1 is designed to be launched at least by a standard firearm 19, and the video guided munition 1 is designed to be small enough and aerodynamically efficient enough that when launched with a cartridge 30 with power equivalent or less than a standard NATO 7.62×51 mm cartridge 30, the video guided munition 1 will be able to reach a range 17 of at least 200 meters on level ground at sea level. The size of the video guided munition, in both weight and cross sectional area, limits the range 17 the video guided munition 1 is capable of reach when launched by a cartridge 30 of given power using an adapter 20 to launch the video guided munition 1 from a standard firearm 19. If the video guided munition 1 were too heavy, it would not be able to reach a range 17 of at least 200 meters at sea level on level ground when launched from a standard firearm 19 using a cartridge 30 no more powerful than a NATO standard 7.62×51 mm cartridge 30. Similarly, if the cross-sectional area of the video guided munition 1 is too great, the drag will be too high for the video guided munition 1 to reach this range 17. As noted above, this is generally at the low end of the minimum range 17 that a practical guided munition would require to be useful on the modern battlefield. To date, nearly all guided munitions would be too large to satisfy this requirement without using any on-board propulsion; which is why no prior art devices with explosive warheads have been created in the prior art that are practical enough, low enough in cost, and effective enough in range 17 to deploy to a large fraction of troops, and it is why prior art systems use at least one of on-board propulsion systems and dedicated launchers, driving cost and portability to a point where prior art systems cannot be distributed to the average battlefield soldier. These design requirements may, however, result in any suitable benefits. In another preferred variation, when launched from a standard firearm 19 with a cartridge 30 no more powerful than a NATO standard 7.62×51 mm cartridge 30, the video guided munition 1 is small enough to reach a range 17 on level ground at sea level of at least 400 meters. In another preferred variation, the video guided munition 1 may be small enough and designed properly to reach targets at a range 17 of at least 200 meters on level ground at sea level when launched by a firearm 19 discharging a 5.56×45 mm NATO cartridge 30. In another preferred variation, the video guided munition 1 may be small enough and designed properly to reach targets at a range 17 of at least 400 meters on level ground at sea level when launched by a firearm 19 discharging a 5.56×45 mm NATO cartridge 30. In a variation of this variation, this may require the attachment of at least one wing. The system of the preferred embodiments may, however, have any suitable range 17 and may be launched by any suitable firearm 19 with any suitable cartridge 30. The system of the preferred embodiments may, however, be launched by any suitable means.

In a preferred variation, the video camera 5 may be a night vision camera. In another preferred variation, the video camera 5 may be an infrared imaging system. At the moment, these systems may be prohibitively expensive to achieve the goals of the system, however for specified roles these systems may make sense to allow night operations and operations with vegetation covering, and additionally future versions of these sensing technologies may be lower cost. The video camera 5 may, however, be only a visible light camera. The video camera 5 may, however, have any suitable design.

In a preferred variation, as shown in FIGS. 5 and 7, at least one wing may be attached to the body 2 of the video guided munition. The wing preferably allows the range 17 of the video guided munition 1 to be extended. Rifle grenades of the prior art generally have ranges of less than 400 meters, and generally their ranges are closer to 200 meters. This is because a munition with at least one of a warhead and a payload 14 large enough to be sufficiently effective against real world battlefield situations is generally large enough and heavy enough that the kinetic energy that can be imparted by launching the munition with a standard firearm is not enough to get such a munition to a range farther than 400 meters, and often the kinetic energy is not enough to get the munition farther than roughly 150-250 meters. In order to extend the range 17 of the video guided munition 1 while the energy that can be produced by launching with a standard firearm 19 is fixed, a wing may be required. In this preferred variation, the lift provided by the wing allows the video guided munition 1 to break free from a simple ballistic trajectory and glide enough to extend the range 17 to a usable distance. This may allow larger video guided munitions to reach a distance of at least 200 meters, and may allow the same sized video guided munitions to reach greater ranges 17. In order to deliver a munition with a warhead of sufficient size to distances beyond 400 meters after launching the video guided munition 1 with a standard firearm 19 with a cartridge 30 no more powerful than a 7.62×51 mm NATO cartridge 30, it may be necessary to include a wing on the video guided munition. This is even more true when launching the video guided munition 1 by discharging a NATO standard 5.56×45 mm cartridge 30. In order to reach a range 17 of much greater than 400 meters with a sufficient sized warhead while being launched by a standard 7.62×51 mm NATO cartridge 30, and without on-board propulsion, it is almost certain that a wing must be included in the video guided munition 1 because of the limited launch energy available. Again, this is even more true if launching the video guided munition 1 by discharging a 5.56×45 mm NATO cartridge 30. For this reason, in this preferred variation the wing greatly separates this variation from the prior art and helps the system meet a long standing need. In order to provide proper aerodynamic balance, the wing would generally be mounted so that the quarter chord of the wing roughly aligns with the center of gravity 24 of the video guided munition, allowing stable flight of the video guided munition. Preferably the wing is mounted at a distance 25 from the center of gravity that is within three inches of the center of gravity 24 of the video guided munition, generally the video guided munition 1 would be unstable in flight if this were not the case. The wing also must have sufficient surface area to provide enough lift to provide significant range 17 extension to the video guided munition, and this would generally be at least a total wing area of six square inches. In a variation where the video guided munition 1 has more than one wing, the total surface area of the multiple wings 23 would need to be at least six square inches. In another preferred variation, the total wing area may be at least ten square inches. In a preferred variation, the wing has an airfoil cross section designed to help create lift with less drag. In another preferred variation, the wing is made without an airfoil cross section, having instead a rectangular cross section from the material used to create the wing. In one variation of this variation, the wing may have a roughly rectangular cross section because it is at least one of cut from sheet metal and fabricated from a simple polymer composite material. In another variation of this variation, the at least one wing may be cut from sheet metal and then stamped to introduce at least one of a curve and a crease mimicking an airfoil shape to increase efficiency and strength. In a preferred variation, the video guided munition 1 weighs no more than three pounds, helping it to achieve the desired range 17. In another variation, the video guided munition 1 weighs no more than two pounds. In another variation, the video guided munition 1 weighs no more than one and a half pounds. In another variation, the video guided munition 1 weighs no more than one pound. In these variations the video guided munition 1 is further distinguished from prior art systems, including the unguided RPG rockets and similar devices, which weigh over four pounds and which would not be capable of reaching the desired ranges when launched by a standard firearm with a cartridge no more powerful than a NATO standard 7.62×51 mm cartridge. In a preferred variation, as shown in FIG. 7, the wings 23 may be designed in at least two segments and may be designed to at least one of fold and pivot in order to take up less space for storage and transport. In a variation of this variation, the wings 23 can be stored in a position at least one of folded and pivoted into a smaller space so that a user 12 may more easily carry one or more video guided munitions, and then the user 12 may manually move the wings 23 to the flight position for use. In a variation of this variation, the wing segments 23 may at least one of snap and lock into place. In another variation, the wing segments 23 may be spring loaded and fixed with a trigger mechanism designed to return the wing segments 23 to flight position after launch. In another variation, a single wing segment 23 may pivot to align with the axis of the video guided munition 1 body 2 to create more compact storage. The at least one wing may, however, have any suitable design for taking up less space when stored and transported. The at least one wing may, however, have no means for moving into a lower space configuration. The at least one wing may, however, be made of any suitable materials with any suitable cross section and with any suitable design. The at least one wing may, however, have any suitable size and be attached in any suitable position. There may, however, be no wing at all.

As can be seen, while there is a long standing need for a guided munition that meets the requirements for being distributed to a large fraction of the troops on the battlefield, many specific design decisions and features must be made in order to create a system that may practically fill this need.

### 2. Second Preferred Embodiment

As shown in FIG. 8, the system of the second preferred embodiments is a rifle launched guided munition 101 including: a body 2; at least two fin segments 3 attached to the body 2 near the rear of the body 2; at least two actuators 4 attached to at least one of the fins and the body 2, where the actuators 4 are adapted to move at least one of A) a control surface 31 on at least one of the fins and the B) fins, where the movement creates aerodynamic forces adapted to control the direction of the flight of the munition; a control means including at least one of I) an automated feedback control system 28, II) a control system 28 providing automated guidance control based on sensor 29 input, and III) a control receiver 7 adapted to receive electromagnetic control signals from a control signal transmitter 35; at least one of an explosive warhead 14 and a non-lethal weapons payload; an adapter 20 that allows the munition to be launched by a standard firearm 19. The system of the second preferred embodiments is preferably designed as a rifle launched guided munition 101 with sufficient range 17, low enough cost, and small enough size that it may be the first guided system that may be distributed to a large fraction of the troops on the battlefield. The system of the second preferred embodiments may, however, be used for any suitable purpose. The system of the second preferred embodiments may use any of the suitable features and design information from the first preferred embodiments, except that it is designed fully around being launched by a standard firearm 19 and in some variations may include more automated feedback control. Where a system is not described in the description of the second preferred embodiments, refer to the description in the first preferred embodiments.

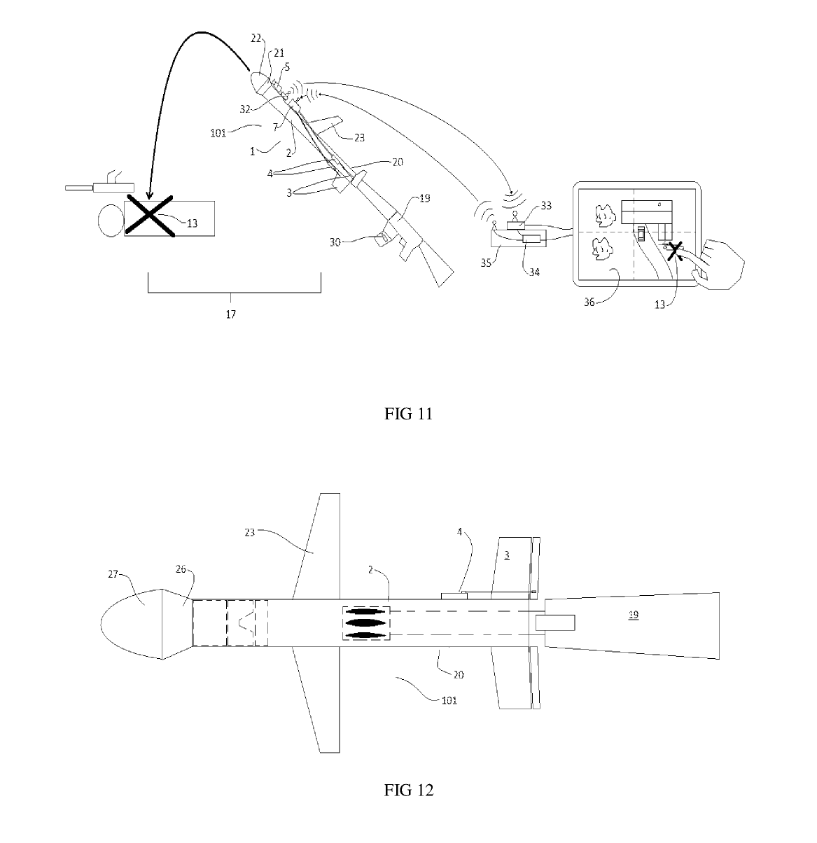

As shown in FIG. 11, in one preferred variation the rifle launched guided munition 101 of the second preferred embodiments includes: a video camera 5 mounted at least one of I) to the body 2 and II) to another component mounted to the body 2; a video transmitter 6 in electrical communication with the video camera 5 and designed to transmit video from the video camera 5; a receiver adapted to receive electromagnetic control signals, where the receiver is in electrical communication with the at least two actuators 4, where the receiver is designed to provide control signals to the at least two actuators 4; a control signal transmitter 35, where the control signal transmitter 35 is adapted to transmit electromagnetic control signals to the receiver; control inputs 9 mounted on the control signal transmitter 35 and designed to allow a user 12 to provide control inputs 9 to the control signal transmitter 35; a video receiver 11 in electrical communication with a video display 10, where the video receiver 11 is designed to receive the video transmitted by the video transmitter 6, where the video display 10 shows video transmitted by the video transmitter 6 to the user 12; where the user 12 reacts to the transmitted video on the video display 10 to provide control inputs 9 to guide the rifle launched guided munition 101 to a desired target point 13.

As shown in FIG. 10, the system of the second preferred embodiments may also include an automated control system 28; where at least one of a video sensor 29, a laser sensor 29, and an infrared sensor 29 is attached to the body 2, where the output from at least one of the video sensor 29, the laser sensor 29, and the infrared sensor 29 is transmitted by a sensor signal transmitter 32 to a sensor signal receiver 33 attached to a ground control station controlled by a user 12; where the ground control station is small enough to be transported by a single human user 12; where the ground control station comprises a control circuit 34 adapted to execute a control algorithm taking the sensor 29 signal as an input; where the control algorithm outputs a control signal; where a control signal transmitter 35 transmits the control signal to a control receiver 7 attached to the body 2; where the control receiver 7 is designed to control the actuators 4 to guide the rifle launched guided munition 101; where the control circuit 34 is at least one of an analog control circuit 34 and a digital computing circuit. Because the ground control station is not expended with the use of each rifle launched guided munition 101, the ground control station can be provided with a control circuit 34 and the design and means for executing automated feedback control without driving up the cost of the rifle launched guided munitions 101, while the control signal transmitter 35 can transmit the controls to the rifle launched guided munition 101 to guide it without any increase in the sophistication and cost of the systems on-board the rifle launched guided munition 101. The ground control station can also do any necessary signals processing and any other required functions necessary to successfully execute a feedback control algorithm. Because powerful consumer electronics and troop carried computing devices are affordable and widely available, but flight weight logic and control systems 28 are not as affordable and widely available, and may need to be custom-made and designed, this variation may have many advantages in cost and achieving the goal of widespread distribution of a guided munition to troops. The control system 28 may, however, have any suitable design and be carried out with any suitable algorithms and with any suitable hardware.

In another variation, the rifle launched guided munition 101 may have on-board feedback control circuit 34ry, where the at least one sensor 29 signal is used in a feedback control algorithm to control the actuators 4. In a variation of this variation, this may be used along with control from a received control signal sent by a ground based control signal transmitter 35, which may provide controls from at least one of a user 12 and a control algorithm executed by the ground based control system 28. A lightweight guided munition capable of being transported by individual soldiers and also capable of reaching ranges over 200 meters while being launched by a firearm discharging a cartridge no more powerful than a NATO standard 7.62×51 mm cartridge does not exist in the prior art, but as noted previously there is without doubt a long standing established need for a device of this nature.

As shown in FIG. 11, in a preferred variation the ground control station comprises a touch screen display, where the rifle launched guided munition 101 comprises a video sensor 29, where the touch screen display is adapted to display video from the video sensor 29 that has been received by the sensor signal receiver 33, where the touch screen display is adapted to sense the position of touch of a user 12, where the user 12 touches the location on the touch sensitive display 36 of a desired target, where the control algorithm outputs a control signal which guides the rifle launched guided munition 101 towards impacting the location in the video that the user 12 has designated by touching the touch sensitive display 36. In a variation of this variation, the ground control station may include a computing tablet, and the control circuit 34 may include the processor and computer readable storage medium of the computing tablet, where the control algorithm may be stored on the computer readable storage medium in software code. In this variation, the skill required by the user 12 to guide the rifle launched guided munition 101 to a desired target point 13 is greatly reduced as the user 12 is not directly controlling the actuators 4, however the control algorithm is also simplified significantly and is executed by the ground control station and not by any expensive on-board systems on the rifle launched guided munition 101, which keeps the cost of each munition down significantly. Furthermore, because in this variation the user 12 is doing the image recognition and target designation, there is no requirement for expensive and difficult to develop systems that can execute image tracking and recognition. There may, however, be any suitable display and control system 28 for the system of the second preferred embodiments.

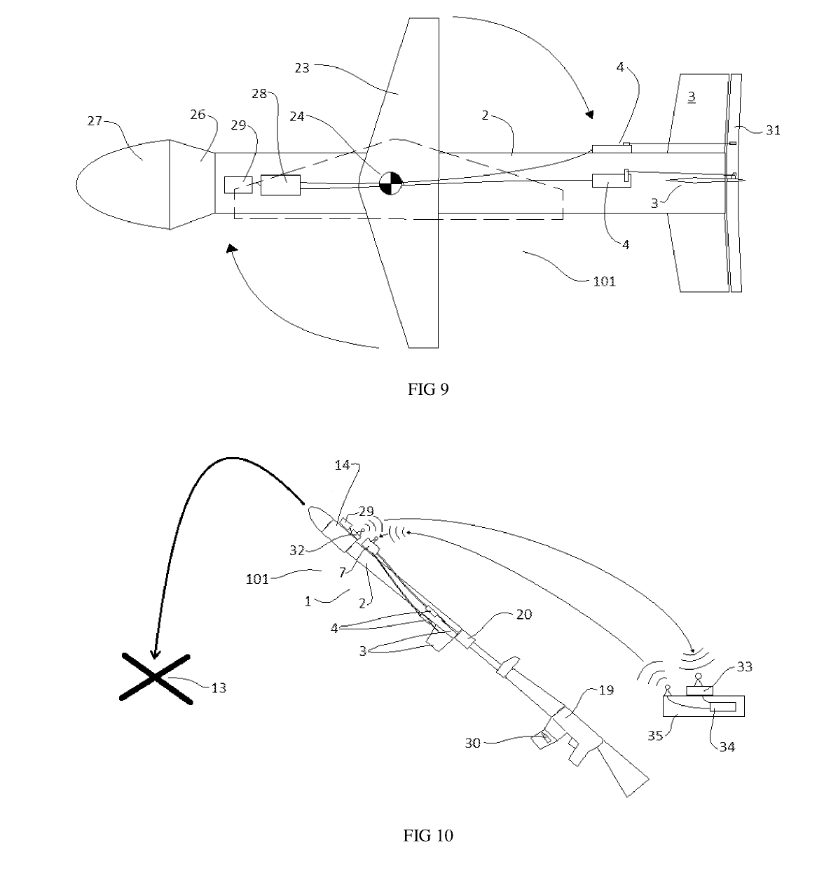

As shown in FIG. 9, the system of the second preferred embodiments may include at least one wing segment 23. The total wing area is preferably at least six square inches. The at least one wing segment 23 may at least one of pivot and fold to reduce size for storage and transport. The at least one wing segment 23 is preferably attached to the body 2 within three inches of the center of gravity 24. In another preferred variation with two or more wing segments 23 separated along the length of the rifle launched guided munition 101, the center of pressure of the two or more wing segments 23 would be within at least three inches of the center of gravity 24. In a preferred variation, the rifle launched guided munition 101 weighs no more than three pounds. In another preferred variation, the rifle launched guided munition 101 weighs no more than two pounds. In another preferred variation, the rifle launched guided munition 101 weighs no more than one and a half pounds. In another preferred variation, the rifle launched guided munition 101 weighs no more than one pound.

As shown in FIG. 10, in a preferred variation the rifle launched guided munition 101 is small enough that the rifle launched guided munition 101 can reach a range 17 of at least 200 meters at sea level on flat ground when launched at the optimum angle for range 17 by an adapter 20 that allows the munition to be launched by a firearm 19, wherein the firearm 19 is no more powerful than a firearm 19 firing a 7.62×51 mm NATO cartridge 30. In another preferred variation, the rifle launched guided munition 101 is small enough that the rifle launched guided munition 101 can reach a range 17 of at least 400 meters at sea level on flat ground when launched at the optimum angle for range 17 by an adapter 20 that allows the munition to be launched by a firearm 19, wherein the firearm 19 is no more powerful than a firearm 19 firing a 7.62×51 mm NATO cartridge 30. The system of the second preferred embodiments may, however, have any suitable range 17. In another preferred variation, the rifle launched guided munition 101 may be small enough and designed properly to reach targets at a range 17 of at least 200 meters on level ground at sea level when launched by a firearm 19 discharging a 5.56×45 mm NATO cartridge 30. In another preferred variation, the rifle launched guided munition 101 may be small enough and designed properly to reach targets at a range 17 of at least 400 meters on level ground at sea level when launched by a firearm 19 discharging a 5.56×45 mm NATO cartridge 30. In a variation of this variation, this may require the attachment of at least one wing 23.

In a preferred variation, the rifle launched guided munition 101 of the second preferred embodiments does not include any on-board propulsion system. In a preferred variation, the rifle launched guided munition 101 of the second preferred embodiments includes none of: laser guidance control sensors 29, infrared seeking sensors 29, GPS guidance control sensors 29, and RADAR guidance control sensors 29 are used in providing input to the actuators 4, where the rifle launched guided munition 101 does not provide any input to the actuators 4 based on automated feedback from any type of sensor 29 other than gyroscopic sensors 29, accelerometers, and inertial sensors 29, wherein this reduces the cost of the video guided munition. There may, however, be any suitable control inputs 9 and any suitable control sensors 29. In a preferred variation, the body 2 is attached to a tubular adapted that is adapted to slide over the flash hider of a standard military rifle, wherein firing the rifle launches the rifle guided munition.

In a preferred variation of the system of the second preferred embodiments, the rifle launched guided munition 101 further includes a warhead adapter 26, where the warhead adapter 26 is adapted to attach to at least one of A) the projectile 27 from a NATO standard 40 mm grenade launcher round, B) the projectile 27 from a NATO standard 25 mm grenade launcher round, C) a NATO standard 40 mm grenade launcher warhead 27, and D) a NATO standard 25 mm grenade launcher warhead 27, where the at least one of A) the projectile 27 from a NATO standard 40 mm grenade launcher round, B) the projectile 27 from a NATO standard 25 mm grenade launcher round, C) a NATO standard 40 mm grenade launcher warhead 27, and D) a NATO standard 25 mm grenade launcher warhead 27 acts as the explosive warhead 14 of the video guided munition. In another preferred variation, the rifle launched guided munition 101 further includes a warhead adapter 21 attached to the body 2, wherein the warhead adapter 21 is adapted to attach at least one of 1) an existing grenade 22, 2) an existing grenade warhead 22, and 3) a grenade projectile 22 from an existing grenade launcher to the body 2, wherein the at least one of 1) the existing grenade 22, 2) the existing grenade warhead 22, and 3) the grenade projectile 22 from an existing grenade launcher acts as the explosive warhead 14 of the rifle launched guided munition 101. In another preferred variation, the rifle launched guided munition 101 includes a purpose built warhead. In another preferred variation, the rifle launched guided munition 101 delivers a non-lethal weapons payload. The rifle launched guided munition 101 may, however, deliver any suitable weapons payload.

As a person skilled in the art will recognize from the previous detailed description and from the figures and claims, modifications and changes can be made to the preferred embodiments of the invention without departing from the scope of this invention defined in the following claims.

I claim:

1) A video guided munition comprising: a body; at least two fin segments attached to the body near the rear of the body; at least two actuators attached to at least one of the fins and the body, wherein the actuators are adapted to move at least one of A) a control surface on at least one of the fins and B) the fins, wherein the movement creates aerodynamic forces adapted to control the direction of the flight of the munition; a video camera mounted at least one of I) to the body and II) to another component mounted to the body; a video transmitter in electrical communication with the video camera and adapted to transmit video from the video camera; a control receiver adapted to receive electromagnetic control signals, wherein the control receiver is in electrical communication with the at least two actuators, wherein the control receiver is adapted to provide control signals to the at least two actuators; a control transmitter, wherein the control transmitter is adapted to transmit electromagnetic control signals to the control receiver; control inputs mounted on the control transmitter and adapted to allow a user to provide control inputs to the control transmitter; a video display; a video receiver in electrical communication with the video display, wherein the video receiver is adapted to receive the video transmitted by the video transmitter, wherein the video display shows video transmitted by the video transmitter to the user; wherein the user reacts to the transmitted video on the video display to provide control inputs to guide the video guided munition to a desired target point; at least one of an explosive warhead and a non-lethal weapons payload; a launch system comprising at least one of 1) an elastic launcher, 2) a spring launcher, 3) a compressed gas launcher, and 4) an adapter that allows the munition to be launched by a firearm.

2) The video guided munition of claim 1, wherein the video guided munition is small enough that the video guided munition can reach a range of at least 200 meters at sea level on level ground when launched at the optimum angle for range by at least one of 1) an elastic launcher weighing less than 20 pounds, 2) a spring launcher weighing less than 20 pounds, and 3) an adapter that allows the munition to be launched by a firearm, wherein the firearm is no more powerful than a firearm firing a 7.62×51 mm NATO cartridge.

3) The video guided munition of claim 1, wherein none of laser guidance control sensors, infrared seeking sensors, GPS guidance control sensors, and RADAR guidance control sensors are used to provide input to control the actuators, wherein this reduces the cost of the video guided munition.

4) The video guided munition of claim 2, wherein the video guided munition does not include any on-board propulsion system, wherein none of laser guidance control sensors, infrared seeking sensors, GPS guidance control sensors, and RADAR guidance control sensors provide input used in controlling the actuators, wherein this reduces the cost of the video guided munition.

5) The video guided munition of claim 4, wherein the video guided munition does not provide any input to the actuators based on automated feedback from any type of sensor other than gyroscopic sensors, accelerometers, and inertial sensors.

6) The video guided munition of claim 5, wherein the video guided munition does not provide any input to the actuators based on automated feedback from any type of sensor, wherein all control is provided through by the user through the control transmitter.

7) The video guided munition of claim 1, further comprising at least one wing attached to the body within three inches of the center of gravity of the video guided munition, wherein the total wing surface area is at least six square inches, wherein the video guided munition weighs no more than three pounds.

8) The video guided munition of claim 2, further comprising at least one wing attached to the body within three inches of the center of gravity of the video guided munition, wherein the total wing surface area is at least six square inches, wherein the video guided munition weighs no more than three pounds.

9) The video guided munition of claim 6, further comprising at least one wing attached to the body within three inches of the center of gravity of the video guided munition, wherein the total wing surface area is at least six square inches, wherein the video guided munition weighs no more than three pounds.

10) The video guided munition of claim 8, wherein the at least one wing is adapted to at least one of fold and pivot to take up less space for storage.

11) A rifle launched guided munition comprising: a body; at least two fin segments attached to the body near the rear of the body; at least two actuators attached to at least one of the fins and the body, wherein the actuators are adapted to move at least one of A) a control surface on at least one of the fins and the B) fins, wherein the movement creates aerodynamic forces adapted to control the direction of the flight of the munition; a control means including at least one of I) an automated feedback control system, II) a control system providing automated guidance control based on sensor input, and III) a control receiver adapted to receive electromagnetic control signals from a control transmitter; at least one of an explosive warhead and a non-lethal weapons payload; an adapter that allows the munition to be launched by a standard firearm.

12) The rifle launched guided munition of claim 11 further comprising: a video camera mounted at least one of I) to the body and II) to another component mounted to the body; a video transmitter in electrical communication with the video camera and adapted to transmit video from the video camera; a receiver adapted to receive electromagnetic control signals, wherein the receiver is in electrical communication with the at least two actuators, wherein the receiver is adapted to provide control signals to the at least two actuators; a control transmitter, wherein the control transmitter is adapted to transmit electromagnetic control signals to the receiver; control inputs mounted on the control transmitter and adapted to allow a user to provide control inputs to the control transmitter; a video receiver in electrical communication with a video display, wherein the video receiver is adapted to receive the video transmitted by the video transmitter, wherein the video display shows video transmitted by the video transmitter to the user; wherein the user reacts to the transmitted video on the video display to provide control inputs to guide the rifle launched guided munition to a desired target point.

13) The rifle launched guided munition of claim 11, wherein the rifle launched guided munition is small enough that the rifle launched guided munition can reach a range of at least 200 meters at sea level on flat ground when launched at the optimum angle for range by an adapter that allows the munition to be launched by a firearm, wherein the firearm is no more powerful than a firearm firing a 7.62×51 mm NATO cartridge.

14) The rifle launched guided munition of claim 11, further comprising at least one wing attached to the body within three inches of the center of gravity of the video guided munition, wherein the total wing surface area is at least six square inches, wherein the video guided munition weighs no more than three pounds.

15) The rifle launched guided munition of claim 12, further comprising at least one wing attached to the body within three inches of the center of gravity of the video guided munition, wherein the total wing surface area is at least six square inches, wherein the video guided munition weighs no more than three pounds.

16) The rifle launched guided munition of claim 13, further comprising at least one wing attached to the body within three inches of the center of gravity of the video guided munition, wherein the total wing surface area is at least six square inches, wherein the video guided munition weighs no more than three pounds.

17) The rifle launched guided munition of claim 11, further comprising an automated control system; wherein at least one of a video sensor, a laser sensor, and an infrared sensor is attached to the body, wherein the output from at least one of the video sensor, the laser sensor, and the infrared sensor is transmitted by a sensor signal transmitter to a sensor signal receiver attached to a ground control station controlled by a user; wherein the ground control station is small enough to be transported by a single human user; wherein the ground control station comprises a control circuit adapted to execute a control algorithm taking the sensor signal as an input; wherein the control algorithm outputs a control signal; wherein a control transmitter transmits the control signal to a control receiver attached to the body; wherein the control receiver is adapted to control the actuators to guide the rifle launched guided munition; wherein the control circuit is at least one of an analog control circuit and a digital computing circuit.

18) The rifle launched guided munition of claim 13, further comprising an automated control system; wherein at least one of a video sensor, a laser sensor, and an infrared sensor is attached to the body, wherein the output from at least one of the video sensor, the laser sensor, and the infrared sensor is transmitted by a sensor signal transmitter to a receiver attached to a ground control station controlled by a user; wherein the ground control station is small enough to be transported by a single human user; wherein the ground control station comprises a control circuit adapted to execute a control algorithm taking the sensor signal as an input; wherein the control algorithm outputs a control signal; wherein a control transmitter transmits the control signal to a control receiver attached to the body; wherein the control receiver is adapted to control the actuators to guide the rifle launched guided munition; wherein the control circuit is at least one of an analog control circuit and a digital computing circuit.

19) The rifle launched guided munition of claim 12, wherein the rifle launched guided munition is small enough that the rifle launched guided munition can reach a range of at least 200 meters at sea level on level ground when launched at the optimum angle for range by an adapter that allows the munition to be launched by a firearm, wherein the firearm is rifle firing a cartridge no more powerful than a 7.62×51 mm NATO cartridge, wherein the rifle launched guided munition does not include any on-board propulsion system, wherein none of: laser guidance control sensors, infrared seeking sensors, GPS guidance control sensors, and RADAR guidance control sensors are used in providing input to the actuators, wherein the rifle launched guided munition does not provide any input to the actuators based on automated feedback from any type of sensor other than gyroscopic sensors, accelerometers, and inertial sensors, wherein this reduces the cost of the video guided munition.

20) The rifle guided munition of claim 19, further comprising at least one wing attached to the body within three inches of the center of gravity of the video guided munition, wherein the total wing surface area is at least six square inches, wherein the video guided munition weighs no more than one and a half pounds, wherein the rifle launched guided munition can reach a range of at least 400 meters at sea level on level ground when launched at the optimum angle for range by an adapter that allows the munition to be launched by a firearm, wherein the firearm is no more powerful than a firearm firing a 7.62×51 mm NATO cartridge, wherein the rifle guided munition does not have any form of on-board propulsion, wherein the at least one wing is adapted to at least one of fold and pivot to take up less space for storage, wherein the body is attached to a tubular adapted that is adapted to slide over the flash hider of a standard military rifle, wherein firing the rifle launches the rifle guided munition.

21) The video guided munition of claim 1, further comprising a warhead adapter attached to the body, wherein the warhead adapter is adapted to attach at least one of 1) an existing grenade, 2) an existing grenade warhead, and 3) a grenade projectile from an existing grenade launcher to the body, wherein the at least one of 1) the existing grenade, 2) the existing grenade warhead, and 3) the grenade projectile from an existing grenade launcher acts as the explosive warhead of the video guided munition.

22) The video guided munition of claim 21, wherein the warhead adapter is adapted to attach to at least one of A) the projectile from a NATO standard 40 mm grenade launcher round, B) the projectile from a NATO standard 25 mm grenade launcher round, C) a NATO standard 40 mm grenade launcher warhead, and D) a NATO standard 25 mm grenade launcher warhead, wherein the at least one of A) the projectile from a NATO standard 40 mm grenade launcher round, B) the projectile from a NATO standard 25 mm grenade launcher round, C) a NATO standard 40 mm grenade launcher warhead, and D) a NATO standard 25 mm grenade launcher warhead acts as the explosive warhead of the video guided munition.

23) The video guided munition of claim 9, further comprising a warhead adapter attached to the body, wherein the warhead adapter is adapted to attach to at least one of A) the projectile from a NATO standard 40 mm grenade launcher round, B) the projectile from a NATO standard 25 mm grenade launcher round, C) a NATO standard 40 mm grenade launcher warhead, and D) a NATO standard 25 mm grenade launcher warhead, wherein the at least one of A) the projectile from a NATO standard 40 mm grenade launcher round, B) the projectile from a NATO standard 25 mm grenade launcher round, C) a NATO standard 40 mm grenade launcher warhead, and D) a NATO standard 25 mm grenade launcher warhead acts as the explosive warhead of the video guided munition.

24) The rifle launched guided munition of claim 11, further comprising a warhead adapter attached to the body, wherein the warhead adapter is adapted to attach at least one of 1) an existing grenade, 2) an existing grenade warhead, and 3) a grenade projectile from an existing grenade launcher to the body, wherein the at least one of 1) the existing grenade, 2) the existing grenade warhead, and 3) the grenade projectile from an existing grenade launcher acts as the explosive warhead of the rifle launched guided munition.

25) The rifle launched guided munition of claim 13, further comprising a warhead adapter attached to the body, wherein the warhead adapter is adapted to attach to at least one of A) the projectile from a NATO standard 40 mm grenade launcher round, B) the projectile from a NATO standard 25 mm grenade launcher round, C) a NATO standard 40 mm grenade launcher warhead, and D) a NATO standard 25 mm grenade launcher warhead, wherein the at least one of A) the projectile from a NATO standard 40 mm grenade launcher round, B) the projectile from a NATO standard 25 mm grenade launcher round, C) a NATO standard 40 mm grenade launcher warhead, and D) a NATO standard 25 mm grenade launcher warhead acts as the explosive warhead of the rifle launched guided munition.

26) The rifle launched guided munition of claim 18, further comprising a warhead adapter attached to the body, wherein the warhead adapter is adapted to attach at least one of 1) an existing grenade, 2) an existing grenade warhead, and 3) a grenade projectile from an existing grenade launcher to the body, wherein the at least one of 1) the existing grenade, 2) the existing grenade warhead, and 3) the grenade projectile from an existing grenade launcher acts as the explosive warhead of the rifle launched guided munition.

27) The rifle launched guided munition of claim 20, further comprising a warhead adapter attached to the body, wherein the warhead adapter is adapted to attach to at least one of A) the projectile from a NATO standard 40 mm grenade launcher round, B) the projectile from a NATO standard 25 mm grenade launcher round, C) a NATO standard 40 mm grenade launcher warhead, and D) a NATO standard 25 mm grenade launcher warhead, wherein the at least one of A) the projectile from a NATO standard 40 mm grenade launcher round, B) the projectile from a NATO standard 25 mm grenade launcher round, C) a NATO standard 40 mm grenade launcher warhead, and D) a NATO standard 25 mm grenade launcher warhead acts as the explosive warhead of the rifle launched guided munition.

28) The video guided munition of claim 1, further comprising a warhead adapter attached to the body, wherein the warhead adapter is adapted to attach to at least one of A) the projectile from a NATO standard 40 mm grenade launcher round, B) the projectile from a NATO standard 25 mm grenade launcher round, C) a NATO standard 40 mm grenade launcher warhead, and D) a NATO standard 25 mm grenade launcher warhead, wherein the at least one of A) the projectile from a NATO standard 40 mm grenade launcher round, B) the projectile from a NATO standard 25 mm grenade launcher round, C) a NATO standard 40 mm grenade launcher warhead, and D) a NATO standard 25 mm grenade launcher warhead acts as the explosive warhead of the video guided munition, wherein the video guided munition does not include any on-board propulsion system, wherein none of laser guidance control sensors, infrared seeking sensors, GPS guidance control sensors, and RADAR guidance control sensors are used to provide input to the actuators, wherein this reduces the cost of the video guided munition.

29) The rifle launched guided munition of claim 17, wherein the ground control station comprises a touch screen display, wherein the rifle launched guided munition comprises a video sensor, wherein the touch screen display is adapted to display video from the video sensor that has been received by the sensor signal receiver, wherein the touch screen display is adapted to sense the position of touch of a user, wherein the user touches the location on the touch sensitive display of a desired target, wherein the control algorithm outputs a control signal which guides the rifle launched guided munition towards impacting the location in the video that the user has designated by touching the touch sensitive display.

30) The video guided munition of claim 5, wherein at least one of I) an elastic cord, II) an elastic band, and III) an elastic tube is used to launch the video guided munition.

31) The rifle launched guided munition of claim 11, wherein a telescoping tube adapter is fitted over the flash hider of a standard firearm, wherein the telescoping tube is adapted to slide forward past the muzzle of the firearm during launch of the rifle launched guided munition, wherein the movement of the telescoping tube extends the time that the gases discharged from the firearm can propel the rifle launched guided munition and this extends the kinetic energy that discharging a given cartridge can impart on the rifle launched guided munition at launch, wherein at least one of the rifle launched guided munition and an adapter fitted to the rifle launched guided munition is adapted to slide at least one of over and into the telescoping tube.
